(19) United States
(12) Patent Application Publication
(10) Pub. No.: US 2012/0300864 A1
(43) Pub. Date: Nov. 29, 2012

(54) CHANNEL ESTIMATION BASED ON COMBINED CALIBRATION COEFFICIENTS

(75) Inventors: Simone Merlin, San Diego, CA (US); Didier Johannes Richard Van Nee, De Meern (NL); Albert van Zelst, Woerden (NL)

(73) Assignee: QUALCOMM Incorporated, San Diego, CA (US)

(21) Appl. No.: 13/186,321

(22) Filed: Jul. 19, 2011

Related U.S. Application Data
(60) Provisional application No. 61/490,218, filed on May 26, 2011.

(51) Int. Cl. H04L 27/28

(52) U.S. Cl. 375/260

(57) ABSTRACT

Calibration coefficients are combined to provide more robust calibration. In some implementations, calibration coefficients are generated by acquiring two or more sets of calibration coefficients that are associated with different periods of time, different receive devices, or some other condition. These different sets of calibration coefficients are then combined using maximal ratio combining or some other suitable technique. The resulting combined calibration coefficients are used to calibrate implicit channel estimates.

### CLAIM OF PRIORITY

This application claims the benefit of and priority to commonly owned U.S. Provisional Patent Application No. 61/490,218, filed May 26, 2011, and assigned Attorney Docket No. 100129P1, the disclosure of which is hereby incorporated by reference herein.

### BACKGROUND

1. FIELD

This application relates generally to wireless communication and more specifically, but not exclusively, to channel estimation.

2. Introduction

Some types of wireless communication devices employ multiple antennas to provide a higher level of performance as compared to devices that use a single antenna. For example, a wireless local area network (WLAN) access point that supports IEEE 802.11n or 802.11ac may use multiple transmit antennas to provide beamforming-based signal transmission. Typically, beamforming-based signals transmitted from different antennas are adjusted in phase (and optionally amplitude) such that the resulting signal power is focused toward a receiver device (e.g., an access terminal). For convenience, the term beamforming is used herein to refer to transmissions from multiple antennas to a single receiver device (commonly referred to as single user beamforming) or to multiple receiver devices (commonly referred to as space division multiple access (SDMA)).

In some aspects, beamforming provides improved performance (e.g., higher throughput and/or greater reliability) due to the additional dimensionalities provided by the spatial streams transmitted by the transmit antennas. In some implementations, beamforming is employed in conjunction with orthogonal frequency division multiplexing (OFDM) techniques to provide more reliable performance under adverse channel conditions.

To provide accurate beamforming, the characteristics of a transmit channel through which beamformed signals are to be sent are taken into account when generating these signals. This transmit channel includes the effects of: 1) the device's transmit chains; 2) the physical channel (including free space) between the transmit and receive antennas; and 3) the receiver device's receive chain(s). Accordingly, the device supports one or more schemes for obtaining an estimate of this transmit channel. Two conventional schemes for estimating a transmit channel (e.g., a downlink channel of an access point) are an explicit feedback scheme and an implicit feedback scheme.

In an explicit feedback scheme, the device sends a training message to at least one other device (e.g., one or more access terminals). Each of these other devices estimates the transmit channel based on the received training sequence and computes a numeric representation of the corresponding channel. Specifically, the numeric representation provides an estimate of any phase shift and attenuation imparted on the training sequence by the transmit channel. This information is provided for each transmit and receive antenna pair. The other devices send their respective numeric representations back to the device via a data packet. The device is thus able to obtain an accurate estimate of the transmit channel based on the received numeric representations. Typically, this channel estimate is represented as a matrix that has dimensions corresponding to the number of transmit antennas (at the device) and the number of receive antennas (at the other devices).

In an implicit feedback scheme, the device receives a training message from at least one other device (e.g., one or more access terminals) via a receive channel. The device then estimates the receive channel (e.g., an uplink channel for an access point) based on the received training sequences. Again, this channel estimate is typically represented as a matrix that has dimensions corresponding to the number of transmit antennas (at the other devices) and the number of receive antennas (at the device).

In some implementations, it is more desirable to use an implicit feedback scheme than an explicit feedback scheme. In particular, there is less overhead associated with the implicit feedback scheme since data packets do not need to be sent and since training messages are relatively short. However, the implicit feedback scheme does not provide as accurate of an estimate of the transmit channel (e.g., downlink) due to differences between the transmit and receive circuitry on the transmit channel and the receive channel (e.g., uplink). In particular, due to implementation inaccuracies, the transmit chain and receive chain circuits for the transmit channel will have different phase and amplitude responses than the transmit chain and receive chain circuits for the receive channel.

To address the inaccuracy of the implicit feedback scheme, calibration is employed whereby a calibration factor (e.g., a calibration matrix) is applied to the receive channel estimate. This calibration attempts to compensate for the differences between the transmit and receive chains for the different transmit and receive antenna pairs. In a typical implementation, such calibration employs a calibration matrix that is calculated by dividing an explicit channel estimate matrix by an implicit channel estimate matrix. The resulting calibration matrix is then used to calibrate subsequent implicit channel estimates.

In practice, the estimations represented by the elements of such a calibration matrix will be noisy due to, for example, thermal noise from the transmit and receive circuits of the signal path and/or interference in the channel. Hence, the calibration provided by the calibration matrix will not be entirely accurate. Moreover, channel conditions or other factors such as the number of receive devices will change over time. For example, a channel between a given transmit and receive antenna pair may be indicated as being in a fade condition by the calibration measurements. If this aspect of the calibration matrix is then used for calibration at a later point in time (or for a different receive antenna) that is not subject to the fade condition, the resulting calibrated channel estimate will be inaccurate. As a result, the system may experience significantly lower communication performance.

Accordingly, calibration procedures may need to be repeated quite frequently to provide accurate channel estimation. Consequently, the implicit feedback scheme may still involve substantial overhead since an explicit channel estimate is needed for each new calibration matrix. Thus, there is a need for more efficient techniques for determining channel estimates.

### SUMMARY

A summary of several sample aspects of the disclosure follows. This summary is provided for the convenience of the reader and does not wholly define the breadth of the disclosure. For convenience, the term some aspects is used herein to refer to a single aspect or multiple aspects of the disclosure.

The disclosure relates in some aspects to channel estimation in a case where a device uses multiple transmit antennas to transmit information to one or more devices. In some implementations, the disclosed channel estimation techniques are used in a WLAN system where an access point (AP) provided with multiple antennas uses OFDM and beamforming (e.g., SDMA precoding) to transmit to one or more access terminals, each of which has one or more antennas.

The disclosure relates in some aspects to combining calibration coefficients to provide more robust calibration. In some implementations, calibration coefficients are generated by acquiring two or more sets of calibration coefficients that are associated with different periods of time, different receive devices, or some other condition. These different sets of calibration coefficients are then combined using maximal ratio combining or some other suitable technique. The resulting combined calibration coefficients are used to calibrate implicit channel estimates.

In some aspects, calibration coefficients generated in accordance with the teachings herein provide more accurate calibration coefficients. For example, through the use of weighted combining, successive combinations of calibration coefficients will be more accurate (e.g., noise components of the calibration coefficients are reduced with each successive combination).

In some aspects, calibration coefficients generated in accordance with the teachings herein may be used under a variety of conditions. For example, due to the accuracy of the combined calibration coefficients, the same set of combined calibration coefficients may be used to provide a highly accurate channel estimate even when there are changes in channel conditions and/or receiver devices. Consequently, such a calibration scheme may involve less overhead than conventional calibration schemes.

The disclosure relates in some aspects to a calibration scheme that employs per tone iterative receive normalization combining. In some aspects this calibration scheme involves, for each OFDM tone, scaling the sets of calibration coefficients, combining the scaled sets of calibration coefficients to provide a vector, and then normalizing the resulting vector with respect to one transmit antenna.

The disclosure relates in some aspects to a calibration scheme that employs interpolation across tones and successive combining. In some aspects this calibration scheme involves normalizing the sets of calibration coefficients with respect to one transmit antenna, computing linear interpolation parameters for phase and amplitude across OFDM tones, combining the interpolation parameters, and using the combined interpolation parameters to reconstruct the calibration coefficients.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system configured to provide channel estimation in accordance with the teachings herein;

FIGS. 2 and 3 are a flowchart of several sample aspects of operations performed in conjunction with providing channel estimation in accordance with the teachings herein;

FIG. 4 is a simplified diagram of sample MIMO transmissions;

FIG. 5 is a flowchart of several sample aspects of operations performed in conjunction with a calibration scheme that employs per tone iterative receive normalization combining;

FIG. 6 is a flowchart of several sample aspects of operations performed in conjunction with a calibration scheme that employs interpolation across tones and successive combining;

FIG. 7 is a simplified block diagram of several sample aspects of components that may be employed in communication nodes;

FIG. 8 is a simplified block diagram of several sample aspects of communication components; and

FIG. 9 is a simplified block diagram of several sample aspects of an apparatus configured to provide channel estimation in accordance with the teachings herein.

In accordance with common practice, the features illustrated in the drawings are simplified for clarity and are generally not drawn to scale. That is, the dimensions and spacing of these features are expanded or reduced for clarity in most cases. In addition, for purposes of illustration, the drawings generally do not depict all of the components that are typically employed in a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a communication method for an apparatus comprises: receiving radiofrequency signals at the apparatus; generating a channel estimate based on the received radiofrequency signals; determining a first set of coefficients based on a first pair of channel estimates acquired by the apparatus; determining at least one second set of coefficients based on at least one second pair of channel estimates acquired by the apparatus; combining the first set of coefficients and the at least one second set of coefficients to provide a combined set of coefficients; and applying the combined set of coefficients to the generated channel estimate to provide a calibrated channel estimate. In addition, in some aspects, the method further comprises: receiving other radiofrequency signals at the apparatus; generating another channel estimate based on the received other radiofrequency signals; and applying the combined set of coefficients to the other channel estimate to provide another calibrated channel estimate.

For illustration purposes, various aspects of the disclosure will be described in the context of an access point that communicates with one or more access terminals. It should be appreciated, however, that the teachings herein may be applicable to other types of apparatuses or other similar apparatuses that are referenced using other terminology. For example, in various implementations access points may be referred to or implemented as base stations, wireless access points, and so on, while access terminals may be referred to or implemented as stations, users, clients, user equipment, user devices, and so on.

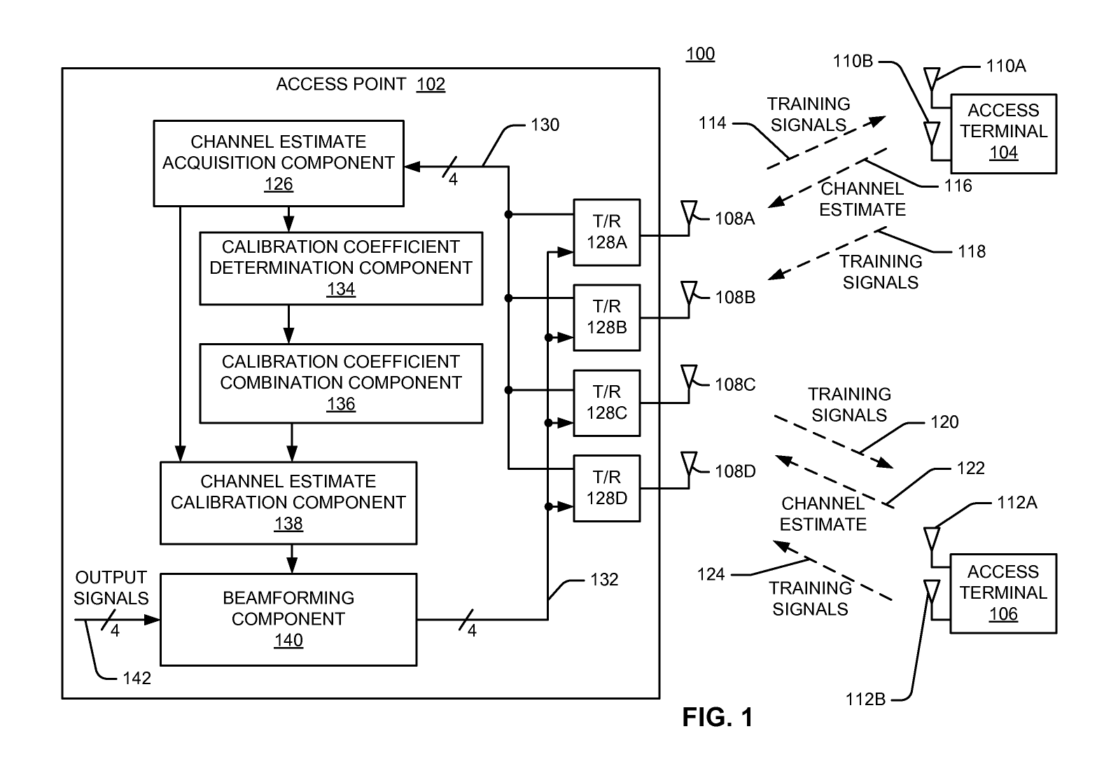

FIG. 1 illustrates sample aspects of a wireless local area network (WLAN) 100 where at various points in time an access point 102 communicates with an access terminal 104 and an access terminal 106. In some implementations, the access point 102 and the access terminals 104 and 106 comprise 802.11n or 802.11ac devices. In the example of FIG. 1, the access point 102 includes four antennas 108A-108D, the access terminal 104 includes two antennas 110A and 110B, and the access terminal 106 includes two antennas 112A and 112B. It should be appreciated that the teachings herein are applicable to other implementations that include a different number of access point antennas, a different number of access terminal antennas, and a different number of access terminals.

The access point 102 employs beamforming (e.g., precoding) for downlink transmissions to the access terminals 104 and 106. Thus, at various points in time, signals are sent from each of the antennas 108A-108D to each of the antennas 110A, 110B, 112A, and 112B.

As shown in the simplified diagram of FIG. 1, the access point 104 includes transmitter/receiver circuits (T/R) 128A-128D for transmitting and receiving signals via the antennas 108A-108D. Here, the transmitter/receiver circuits 128A-128D provide the received signals to other components of the access point 102 via a set of four signal paths 130. Conversely, signals to be transmitted via the antennas 108A-108D are provided to the transmitter/receiver circuits 128A-128D via a set of four signal paths 132.

The access point 104 employs a channel estimate calibration scheme to facilitate accurate beamforming. In some aspects, this scheme involves combining sets of calibration coefficients associated with different channel estimations to provide a more robust set of combined calibration coefficients. To this end, a channel estimate acquisition component 126 acquires implicit channel estimates and explicit channel estimates based on transmissions between the access point 102 and the access terminals 104 and 106.

For example, the access point 102 sends training signals 114 (e.g., comprising a training message) to the access terminal 104, and the access terminal 104 determines an estimate of the channel for that downlink based on the training signals 114. The access terminal 104 then sends a corresponding channel estimate 116 (explicit channel estimate) to the access point 102. In addition, the access terminal 104 sends training signals 118 to the access point 104, and the access point 104 determines an estimate of the channel for that uplink (implicit channel estimate) based on the training signals 118.

Similarly, the access point 102 sends training signals 120 to the access terminal 106 and the access terminal 106 sends a corresponding downlink channel estimate 122 (explicit channel estimate) to the access point 102. The access terminal 106 also sends training signals 124 to the access point 104 so that the access point 104 can determine a corresponding uplink channel estimate (implicit channel estimate).

A calibration coefficient determination component 134 determines calibration coefficients based on the implicit and explicit channel estimates acquired by the channel acquisition component 126. An example of this determination follows. The calibration coefficient determination component 134 determines a first set of calibration coefficients based on the implicit and explicit channel estimates corresponding to measurements made for the access terminal 104 at a first point in time. The calibration coefficient determination component 134 then determines a second set of calibration coefficients based on the implicit and explicit channel estimates corresponding to measurements made for the access terminal 104 at a second (e.g., later) point in time. In addition, the calibration coefficient determination component 134 determines a third set of calibration coefficients based on the implicit and explicit channel estimates corresponding to measurements made for the access terminal 106 (e.g., at the second point in time or at some other point in time).

A calibration coefficient combination component 136 combines the calibration coefficients determined by the calibration coefficient determination component 134. For example, in some implementations, this combination operation involves per tone iterative receive normalization combining as discussed in more detail below. In other implementations, this combination operation involves interpolation across tones and successive combining as discussed in more detail below.

A channel estimate calibration component 138 uses the combined calibration coefficients provided by the calibration coefficient combination component 136 to calibrate implicit channel estimates provided by the channel estimate acquisition component 126. For example, the combined calibration coefficients can be applied to the implicit channel estimate that was used to generate the second set of calibration coefficients discussed above. The combined calibration coefficients also can be applied to the implicit channel estimate that was used to generate the third set of calibration coefficients discussed above. Moreover, the combined calibration coefficients can be applied to implicit channel estimates that the access point 102 acquires later in time.

A beamforming component 140 uses the calibrated channel estimate provided by the channel estimate calibration component 138 to format (e.g., precode) a set of output signals 142 such that the resulting signals are properly beamformed upon transmission by the antennas 108A-108D. For example, in a typical implementation, the calibrated channel estimate is used to generate a beamforming matrix that is, in turn, applied to the output signals 142 to generate the signals provided on the signal paths 132.

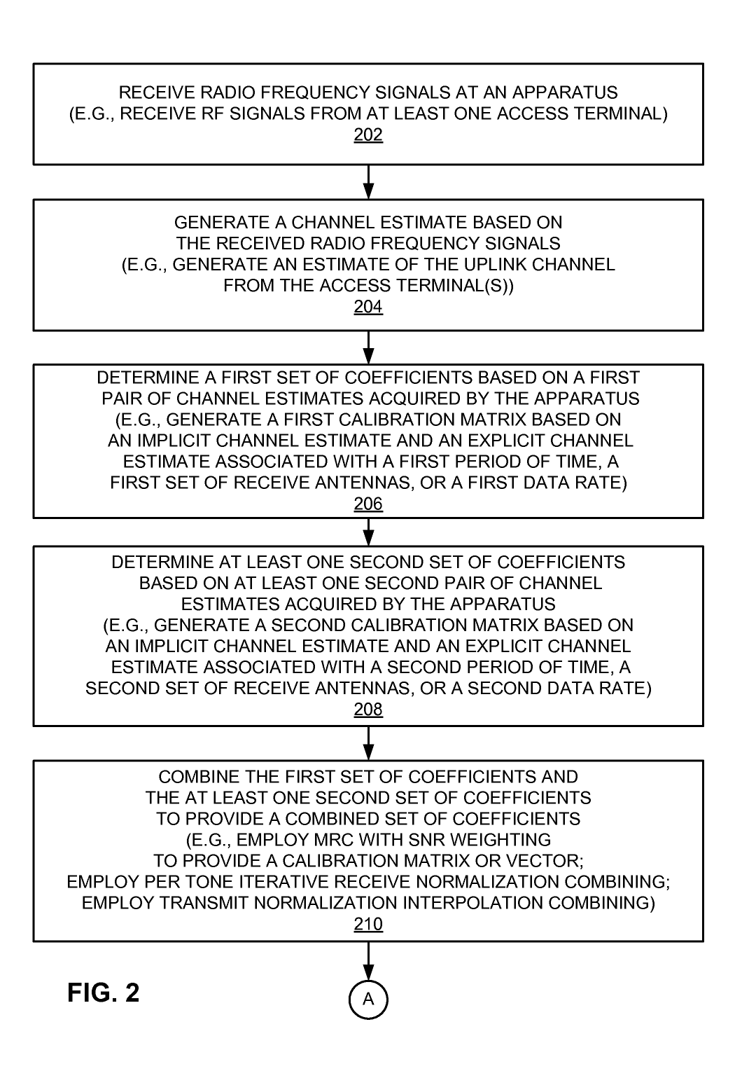

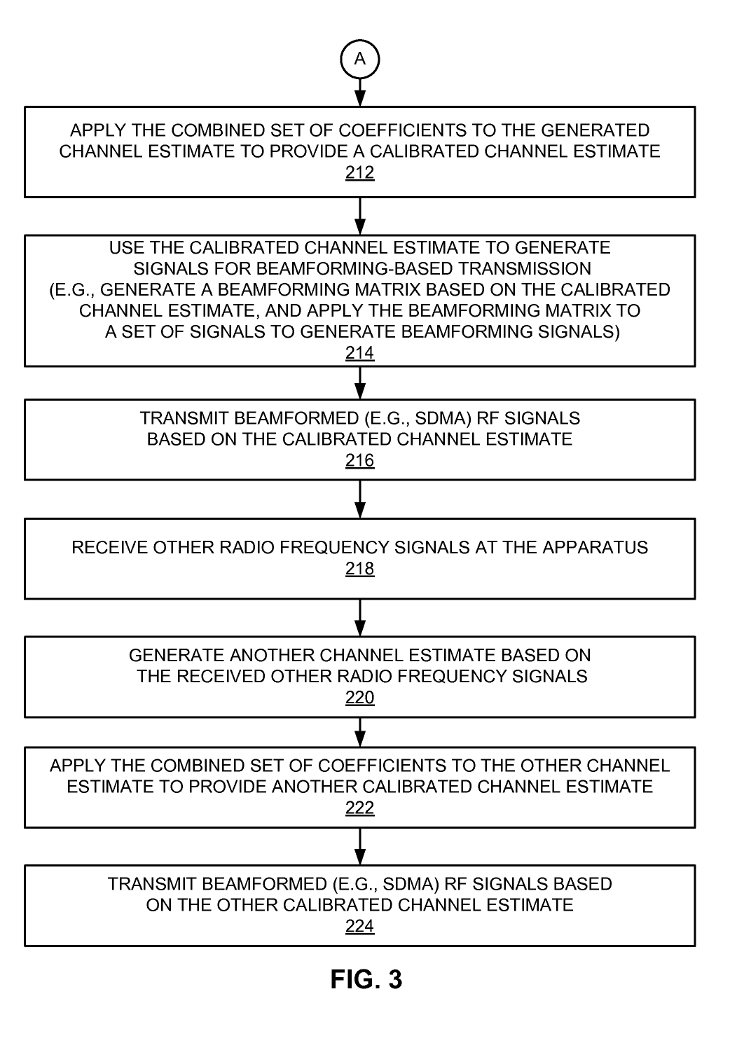

With the above overview in mind, additional details of channel estimation operations in accordance with the teachings herein will be described with reference to the flowchart of FIGS. 2 and 3. For purposes of illustration, the operations discussed herein may be described as being performed by specific components. For example, the operations of FIGS. 2 and 3 are described from the perspective of a first apparatus such as an access point that transmits beamformed signals to at least one other apparatus such as an access terminal. It should be appreciated that these operations may be performed by other types of components and may be performed using a different number of components in other implementations. Also, it should be appreciated that one or more of the operations described herein may not be employed in a given implementation. For example, one entity may perform a subset of the operations and pass the result of those operations to another entity.

Block 202 and 204 of FIG. 2 represent operations where an apparatus (e.g., an access point) generates an implicit channel estimate. As discussed in more detail below, the operations of blocks 202 and 204 may be performed before and/or after the operations of block 206 and/or block 208.

As represented by block 202, at some point in time, radiofrequency (RF) signals are received at the apparatus. For example, an access point receives RF signals comprising a training message from one or more associated access terminals at a given point in time.

As represented by block 204, the apparatus generates a channel estimate based on the received radiofrequency signals. For example, an access point generates an implicit channel estimate for the uplink channel from the access terminal(s) to the access points.

As represented by block 206, the apparatus determines a first set of coefficients based on a first pair of channel estimates acquired by the apparatus. In a typical implementation, the pair of channel estimates comprises an implicit channel estimate and an explicit channel estimate. This pair of channel estimates is associated with a particular condition. In various scenarios, this condition comprises one or more of a period of time, a corresponding set of receive antennas, a data rate being employed for transmission, or some other condition associated with the measurements of the channel estimates (e.g., the processing of received training messages).

In a typical implementation, the set of coefficients is generated by dividing the explicit channel estimate by the implicit channel estimate. This involves a matrix division operation in cases where each channel estimate is represented by a matrix having, for each OFDM tone, elements corresponding to each transmit and receive antenna pair. The resulting calibration matrix thus has dimensions based on the number of tones, the number of transmit antennas, and the number of receive antennas.

As represented by block 208, the apparatus determines at least one second set of coefficients based on at least one second pair of channel estimates acquired by the apparatus. Again, each pair of channel estimates typically comprises an implicit channel estimate and an explicit channel estimate. In addition, each set of coefficients typically is generated by dividing the explicit channel estimate by the implicit channel estimate.

These channel estimate pairs are associated with a condition that is (or conditions that are) different from the condition referred to at block 206. In various scenarios, this condition comprises one or more of a period of time, a corresponding set of receive antennas, a data rate being employed for transmission, or some other condition.

For example, the channel estimates of block 208 may be acquired at a later point in time than the time at which the channel estimates of block 206 were acquired. Thus, in some cases, the first pair of channel estimates corresponds to channel conditions during a first period of time, and the at least one second pair of channel estimates corresponds to channel conditions during at least one second period of time that is later than the first period of time.

As another example, the channel estimates of block 208 may correspond to a different configuration of receive antennas (e.g., at least one additional receive antenna is involved) than the configuration of receive antennas associated with the channel estimates of block 206. Thus, in some cases, the first pair of channel estimates corresponds to a first set of receive antennas, and the at least one second pair of channel estimates corresponds to at least one second set of receive antennas that is different from the first set of receive antennas.

As yet another example, the channel estimates of block 208 may be conducted using a different data rate (e.g., due to a change in distance between the access point and at least one access terminal) than the data rate used for the channel estimates of block 206. Thus, in some cases, the first pair of channel estimates corresponds to transmissions over a channel at at least one first data rate, and the at least one second pair of channel estimates corresponds to transmissions over a channel at at least one second data rate that is different from the at least one first data rate.

In some implementations, each set of coefficients comprises a matrix. For example, in some cases the first set of coefficients comprises a first calibration matrix that relates a first uplink channel estimate to a first downlink channel estimate, and the at least one second set of coefficients comprises a second calibration matrix that relates a second uplink channel estimate to a second downlink channel estimate.

Also, in some cases, one of the implicit channel estimates of block 206 or block 208 is the same implicit channel estimate that was generated at block 204. As discussed in more detail below at block 212, the implicit channel estimate of block 204 is to be calibrated using a set of calibration coefficients generated as described at block 210. Thus, the implicit channel estimate being calibrated at block 212 may be one of the implicit channel estimates that was used to provide the coefficients of block 206 or 208 or it may be some other implicit channel estimate (e.g., acquired at a later point in time).

Accordingly, in some scenarios, the first pair of channel estimates acquired by the apparatus comprises: the channel estimate generated by the apparatus, and a channel estimate received by the apparatus; while the at least one second pair of channel estimates acquired by the apparatus comprises: another channel estimate generated by the apparatus based on other radiofrequency signals received by the apparatus, and another channel estimate received by the apparatus.

Conversely, in other scenarios, the first pair of channel estimates acquired by the apparatus comprises: a first implicit channel estimate generated by the apparatus based on a first set of other radiofrequency signals received by the apparatus, and a first explicit channel estimate received by the apparatus; while the at least one second pair of channel estimates acquired by the apparatus comprises: a second implicit channel estimate generated by the apparatus based on a second set of other radiofrequency signals received by the apparatus, and a second explicit channel estimate received by the apparatus.

As represented by block 210, the apparatus combines the first set of coefficient and the at least one second set of coefficients to provide a combined set of coefficients. This block thus involves combining two or more sets of coefficients using one or more combination operations. In one example scenario, a first set of coefficients and a second set of coefficients are combined to provide the combined set of coefficients. In another example scenario, a first set of coefficients and a second set of coefficients are combined to provide an initial combined set of coefficients; then a third set of coefficients is combined with the initial combined set of coefficients to provide the final combined set of coefficients. It should be appreciated that other sets of coefficients and other combination operations may be employed in other scenarios. In some implementations, the combining of the first set of coefficients and the at least one second set of coefficients comprises maximal ratio combining

The weighting for the maximal ratio combining may be based on signal-to-noise ratios of the coefficients. Thus, in some implementations, the combining of the first set of coefficients and the at least one second set of coefficients comprises combining that is weighted based on signal-to-noise ratios associated with the first set of coefficients and signal-to-noise ratios associated with the at least one second set of coefficients.

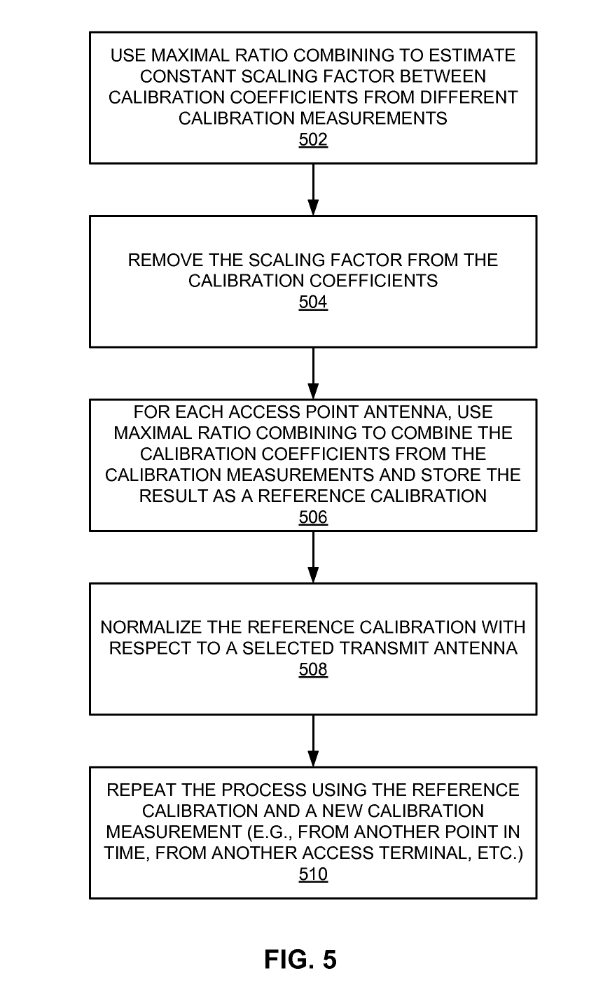

As discussed in more detail below in conjunction with FIG. 5, in some implementations the combining of block 210 employs per tone iterative receive normalization combining. This involves, for example, scaling the first set of coefficients and the at least one second set of coefficients; and, for each transmit antenna of a plurality of transmit antennas at the apparatus, combining the scaled coefficients of the first set of coefficients and the at least one second set of coefficients that are associated with the transmit antenna; and then normalizing the combined coefficients associated with each transmit antenna with respect to a first one of the transmit antennas.

In this example, the combining operation is performed on a tone-by-tone basis. Thus, in some implementations, the combining of the first set of coefficients and the at least one second set of coefficients comprises generating a corresponding calibration matrix or vector for each tone of a set of orthogonal frequency division multiplexing tones used by the apparatus.

The combining of the coefficients for each transmit antenna in the above-described operation involves combining the columns of the matrix into a single column Thus, in some implementations, the combined set of coefficients provided at block 210 is a vector.

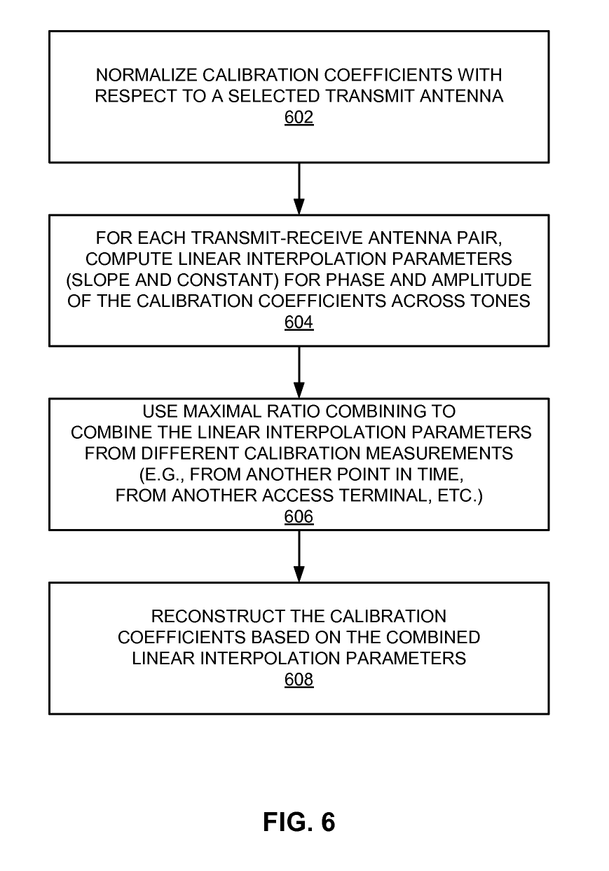

As discussed in more detail below in conjunction with FIG. 6, in some implementations the combining of block 210 employs transmit normalization interpolation combining. This involves, for example, determining sets of linear interpolation phase and amplitude parameters associated with a set of orthogonal frequency division multiplexing tones used by the apparatus; combining the sets of linear interpolation phase and amplitude parameters to provide a combined set of linear interpolation parameters; and calculating the combined set of coefficients based on the combined set of linear interpolation parameters.

Typically, the operations of blocks 208 and 210 are repeated over time. That is, the apparatus will repeatedly determine different sets of calibration coefficients and combine these coefficients with the previous combined set of calibration coefficients. In some implementations, this repetitive combining is accomplished by maintaining (e.g., storing in a memory device) the sets of calibration coefficients. In this case, a sliding window approach may be used whereby older sets of calibration coefficients are discarded at some point. In other implementations, the repetitive combining involves maintaining only the combined set of calibration coefficients. Such an implementation is used, for example, to reduce the processing and/or memory requirements associated with channel estimation.

Advantageously, a more accurate (e.g., less noisy) set of calibration coefficients may be obtained by repeatedly combining sets of calibration coefficients. For example, by weighting the calibration coefficients by their respective SNRs, each successive set of combined calibration coefficients will have a higher SNR for each OFDM tone. Here, if a channel toward a different receive antenna is uncorrelated, it is unlikely that different access terminals will have fading at the same frequencies. Thus, combining as taught herein may be used to extract the best estimate per tone for all access terminal antennas.

Accordingly, a single set of calibration coefficients (e.g., a single calibration vector) provides accurate calibration even when applied to different channel estimates associated with, for example, different periods of time and different receive antennas. In some aspects, this combining provides a single set of calibration coefficients that is used to correct implicit channel estimates referred to different access terminals. In some aspects, this combining provides a single set of calibration coefficients that are more robust with respect to channel variations over time as compared to calibration parameters provided by conventional schemes. In some aspects, this combining provides an increase in the accuracy of the calibration as more channel estimations associated with other access terminals become available.

As represented by block 212 of FIG. 3, the combined set of coefficients generated at block 210 are applied to the channel estimate generated at block 204 to provide a calibrated channel estimate. For example, in a scenario where the combined set of coefficients and the implicit channel estimate are each represented by a matrix, these matrices are multiplied to provide a calibrated channel matrix. In implementations where the apparatus is an access point, this estimate corresponds to a downlink channel of the access point.

As represented by block 214, the apparatus uses the calibrated channel estimate to generate signals for beamforming-based transmission. For example, in some cases a beamforming matrix is generated as a function of a calibrated channel matrix. In a simple example, the beamforming matrix is the inverse of the calibrated channel matrix. Accordingly, in some implementations, the operations of block 212 involve generating a beamforming matrix based on the calibrated channel estimate, and applying the beamforming matrix to a set of signals to generate signals for beamforming-based transmission.

As represented by block 216, the apparatus transmits beamformed (e.g., SDMA precoded) RF signals based on the calibrated channel estimate. That is, the signals generated at block 214 are sent to respective transmit antennas and transmitted to the appropriate receive antennas.

As mentioned above, combined calibration coefficients as taught herein may advantageously be applied to other channel estimates generated by the apparatus. Accordingly, as represented by block 218, at some point in time other radiofrequency signals are received at the apparatus. As represented by block 220, another channel estimate (e.g., an implicit channel estimate) is generated based on the radiofrequency signals received at block 218. As represented by block 222, the combined set of coefficient from block 210 is applied to the other channel estimate to provide another calibrated channel estimate. As represented by block 224, the apparatus transmits beamformed RF signals based on the new calibrated channel estimate of block 222 (e.g., based on a new beamforming matrix generated based on the new calibrated channel estimate). The operations of blocks 218-224 are then repeated as needed to provide an accurate channel estimate on a continual basis.

In conjunction with these dynamic calibration operations, at some point, the apparatus generates a new set of combined calibration coefficients. For example, in some cases, the apparatus will determine a new set of calibration coefficients based on a new pair of implicit and explicit channel estimates, and combine that new set of calibration coefficients with the previous set of combined coefficients. In other cases (e.g., upon detection of a significant change in channel conditions or the access terminal configuration), the apparatus will generate a completely new set of combined calibration coefficients. This would involve, for example, discarding the prior set of combined coefficients followed by conducting the operations of blocks 206-210.

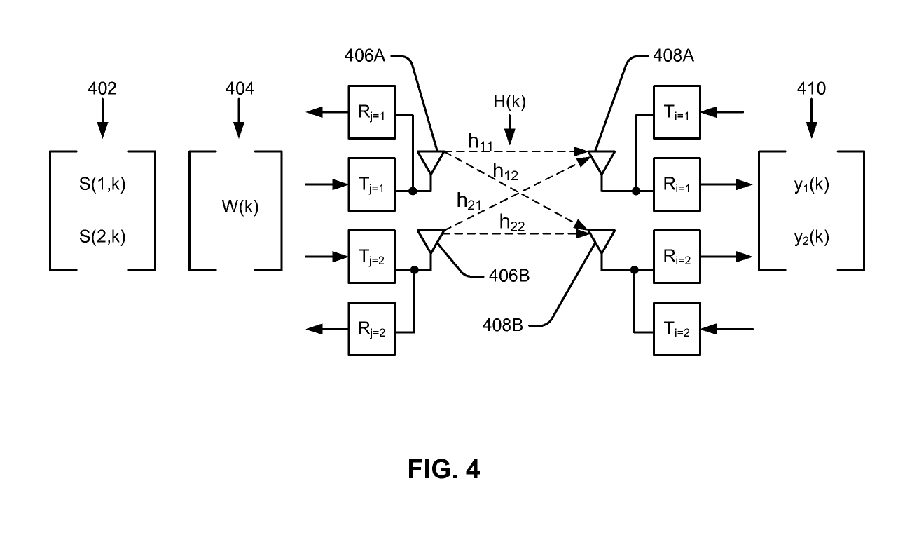

With the above in mind, detailed examples of calibration coefficient combining schemes will be described with reference to FIGS. 4-6. FIGS. 5 and 6 describe two sample combining algorithms. FIG. 4 illustrates a simplified example of signal transmission-related parameters that are referred to in FIGS. 5 and 6.

FIG. 4 illustrates, in a simplified manner, signal transmission from an access point to two access terminals. Here, the access point uses two transmit antennas to send information to the two access terminals, each of which has a single receive antenna.

As represented by the matrix 402, the access point generates an output signal S(1,k) destined for the first access terminal and generates an output signal S(2,k) destined for the second access terminal. The parameter k represents that the signals are sent over k tones using OFDM. The output signals are applied to a beamforming matrix 404 (e.g., with elements W₁₁, W₁₂, W₂₁, and W₂₂ for a 2×2 matrix. The result of this operation is provided to transmit circuitry and then transmitted by the antennas 406A and 406B.

The T and R parameters associated with the antennas 406A and 406B represent the respective transmit circuits (e.g., the transmit chain) and the receive circuits (e.g., the receive chain) for those antennas. In accordance with conventional practice, the access point antennas are indexed by a parameter j. Thus, j=1 corresponds to the first antenna 406A and j=2 corresponds to the second antenna 406B. Typically, each of these parameters is a complex number that represents the amplitude attenuation and the phase rotation imparted on a signal as it passes through the respective circuit. In addition, a unique parameter value may be associated with each OFDM tone. Thus, the parameter Tⱼ₌₁ represents a complex scaling factor that accounts for the RF transmit processing of the access point for a given tone k and transmit antenna j=1. Conversely, the parameter Rⱼ₌₁ represents a complex scaling factor that accounts for the RF receive processing of the access point for a given tone k and receive antenna j=1.

The signals from the antennas 406A and 406B are transmitted via a channel represented by a matrix H(k) to the receive antennas 408A and 408B. The channels associated with the different transmit antenna-receive antenna pairs are represented by the matrix elements h₁₁, h₁₂, h₂₁, and h₂₂ as shown. Typically, each matrix element is a complex number that represents the amplitude attenuation and the phase rotation imparted on a signal as it travels from the corresponding transmit antenna to the corresponding receive antenna.

The T and R parameters associated with the antennas 408A and 408B represent the respective transmit circuits and the receive circuits for those antennas. In accordance with conventional practice, the access terminal antennas are indexed by a parameter i. Thus, i=1 corresponds to the first antenna 408A and i=2 corresponds to the second antenna 408B. As discussed above, each of these parameters typically is a complex number that represents the amplitude attenuation and the phase rotation imparted on a signal as it passes through the respective circuit, and a unique parameter value is typically associated with each OFDM tone. Thus, the parameter Tᵢ₌₁ represents a complex scaling factor that accounts for the RF transmit processing of the access terminal for a given tone k and transmit antenna i=1, while the parameter Rᵢ₌₁ represents a complex scaling factor that accounts for the RF receive processing of the access terminal for a given tone k and a receive antenna i=1.

The received signals are represented by a matrix 410 where, as stated above, one receive antenna is associated with each access terminal. Here, the signal y₁(k) is the signal received at one access terminal and the signal y₂(k) is the signal received at the other access terminal.

With the parameters of FIG. 4 in mind, an example of generating a calibration matrix will now be described. This example is described in terms of a system that is generalized as including J TX antennas (at the access point) and I RX antennas (at the same access terminal or at different access terminals). Again, the parameter k is the index of a subcarrier for OFDM. The parameter H^{k,i,j} is the channel for tone k, RX antenna i and TX antenna j. The parameter T^{k,j} is a transmit complex scaling factor for tone k and TX antenna j accounting for the RF processing. The parameter R^{k,i} is a receive complex scaling factor for tone k and RX antenna i accounting for the RF processing. The implicit (uplink) channel estimate Hᵢₘₚₗ and the explicit (downlink) channel estimate Hₑₓₚₗ each have dimensions [N_{fft}×Nᵣₓ×Nₜₓ] corresponding to the number of tones, receive antennas and transmit antennas. These channel estimates and the calibration matrix C are represented by:

H^{k,i,j}ᵢₘₚₗ=T^{k,i}H^{k,i,j}R^{k,j}

H^{k,i,j}ₑₓₚₗ=T^{k,j}H^{k,i,j}R^{k,i}

C^{k,i,j}=H^{k,i,j}ₑₓₚₗ/H^{k,i,j}ᵢₘₚₗ=T^{k,j}R^{k,i}/T^{k,i}R^{k,j}

Thus, given a channel estimate Hᵢₘₚₗ, and the calibration matrix C, the calibrated channel H′ (e.g., the channel used for the precoder) is calculated by: H′=Hᵢₘₚₗ*C. Here, it is assumed that the channels H^{k,i,j} and H^{k,i,j} between the antennas (e.g., free space) are identical. Accordingly, the calibration matrix C represents the difference between the transmit and receive circuits in the downlink direction (e.g., Tⱼ₌₁, Rᵢ₌₁) and the transmit and receive circuits in the uplink direction (e.g., Tᵢ₌₁, Rᵢ₌₁).

The SNR associated with each element of the calibration matrix is given by: SNR^{k,i,j}=SNRᵢ abs(H^{k,i,j}ᵢₘₚₗ)̂2, where SNRᵢ may be obtained from a channel state information (CSI) report or some other suitable mechanism.

Referring now to the algorithm of FIG. 5, these illustrated operations are performed for each OFDM tone. Thus, at the end of the procedure, one set of calibration coefficients (e.g., a vector) is provided for each tone.

As represented by block 502, maximal ratio combining is used to estimate the constant scaling factor between the calibration coefficients from different calibration measurements. For example, initially, the scaling factor between two different access terminal antennas (e.g., RX antennas) may be estimated.

As represented by block 504, the scaling factor is removed from the calibration coefficients. For example, each coefficient in a given row may be divided by a scaling factor corresponding to that row. At this point of the process, all of the coefficients are normalized.

As represented by block 506, for each access point antenna (e.g., TX antenna), maximal ratio combining is used to combine the coefficients from the calibration measurements. The resulting combination is stored as a reference calibration. This process involves MRC combining the columns of the matrix. Thus, a calibration vector is provided for each transmit antenna at this point. In some implementations, the operations of block 506 are not employed. In this case, the normalized coefficients of block 504 are further normalized at block 508 or are simply used as is for calibration.

As represented by block 508, the reference calibration generated at block 506 is normalized with respect to a selected transmit antenna. For example, the calibration vector for each TX antenna may be divided by the calibration vector for the first TX antenna. This operation removes any phase jumps across tones (e.g., due to received signal-locking delays during signal measurements).

As represented by block 510, the operations of blocks 502-508 are repeated using the reference calibration and another set of calibration measurements (e.g., for another point in time, for another access terminal antenna, etc.).

A detailed example of the algorithm of FIG. 5 follows. In this example, MRC(A,B) stands for maximal ratio combining of A elements with weights B. Again, the following operations are performed for each tone k.

Initially, a reference vector C_{ref}(k,:) corresponding to the first RX antenna is stored. Specifically, C_{ref}(k,:)=C^{k,l,:}. The parameter SNR_{ref}^{k,:} is defined as the SNR of C_{ref}(k,:).

For each RX antenna i=[2:I], the operations that follow are performed:

The scaling factor sᵢₗ between C^{k,i,:} and C_{ref}(k,:) is computed as:

sᵢₗ=MRC(C^{k,i,:}·/C_{ref}(k,:),W^{k,:})

Here, W^{k,:}=1·/(1·/SNR^{k,i,:}+1·/SNR_{ref}^{k,:})

The SNR of each scaling factor is defined as: SNR_{scaling}=sum(W^{k,:})

The scaling factor sᵢₗ is removed as follows: C′^{k,i,:}=C^{k,i,:}/s_{i,l}

At this point, the coefficient matrix is normalized. Next, the columns of the calibration matrix are combined.

For each TX antenna j, the following MRC operations are performed:

C_{ref}(k,j)=MRC([C_{ref}(k,j),C′^{k,i,j}],[G1,G2]), where

G1^{k}=1·/(1·/SNR_{ref}^{k,j}+1·/SNR_{scaling}) and

G2^{k}=1·/(1·/SNR^{k,i,j}+1·/SNR_{scaling})

Here, the columns may advantageously be combined since any differences between access terminals do not have a significant effect on the calibration. Specifically, a goal of beamforming is to have the signals from different transmit antennas align at a given receive antenna. Thus, the alignment depends on the relative phase and amplitude of the different paths from the transmit antennas. In contrast, if there is a constant factor at the receive antennas, this will affect each of the paths in the same way. Thus, the relative phase and amplitude of the transmitted signals is not affected.

The resulting vectors for each TX antenna are normalized with respect to the first TX antenna: C′_{ref}(k,:)=C_{ref}(k,:)/C_{ref}(k,1). The parameter C′_{ref}(k,:) is then used as the reference vector C_{ref}(k,:) in the next iteration of the algorithm.

Assuming the weights used for the MRC are correct, then at each step of the algorithm, the SNR of the calibration coefficients in C_{ref} is greater than in the previous step. Hence, the combined calibration coefficients are more accurate (e.g., less noisy).

In some implementations, only one calibration matrix (e.g., C_{ref}) is stored. Also, in some cases, C_{ref} is updated every time a new channel measurement is available. Here, the SNR will increase as new measurements are combined.

In some implementations, to account for aging in the calibration information, SNR_{ref}^{k,:} is lowered as a function of time. This may be employed, for example, to account for changes in the TX-RX imbalance due to temperature drift.

Referring to FIG. 6, this algorithm employs a multi-step process of normalization, interpolation and combining. Here, linearity across tones is assumed. Because of the normalization (with respect to TX antenna 1), all access terminal contributions to the calibration coefficients are removed. Linearity is thus only assumed at the access point side here.

As represented by block 602, the calibration coefficients are normalized with respect to a selected transmit antenna. For example, the calibration coefficients in a given row of the matrix may be divided by the calibration coefficient for the first TX antenna for that row.

As represented by block 604, for each transmit-receive antenna pair, linear interpolation parameters for phase and amplitude of the calibration coefficients are computed across tones. These parameters correspond to a slope and an associated constant.

As represented by block 606, maximal ratio combining is used to combine linear interpolation parameters associated with different calibration measurements. For example, as discussed herein, different sets of calibration coefficients may correspond to different periods of time, different receive antenna configurations, and so on. Accordingly, in some implementations, the linear interpolation parameters associated with these different conditions are combined at block 606.

As represented by block 608, the calibration coefficients are reconstructed based on the combined linear interpolation parameters. Here, the calibration coefficients are assumed to be of the kind y=d*exp(j*(ax+b)), where the parameters a, b, and d are determined at block 606. In other words, it is assumed that the phase changes linearly with tone (amplitude is assumed to be substantially flat across tones). Thus, for a given tone, this linear equation will indicate where the calibration coefficient value is on the line defined by the linear equation.

A detailed example of the algorithm of FIG. 6 follows. Initially, the following operations are performed for each tone k and for each RX antenna i: The calibration coefficients referred to different TX antennas are divided by the calibration coefficients referred to the first TX antenna: C′^{k,i,j=C}^{k,i,j}/C^{k,i,l}. Thus, a normalized calibration matrix is provided at this point.

For each TX and RX antenna (j,i), the calibration coefficients are linearly interpolated across tones as: C″^{k,i,j}=d_{i,j}*exp(j(a_{i,j}*[1:Nfft]+b_{i,j})). Here, the parameters a and b are computed according to a linear interpolation on the angle(C′^{k,i,j}).

The parameter d_{i,j} is computed on the abs(C′^{k,i,j}) across tones, where a flat frequency profile is assumed:

d_{i,j}=MRC(abs(C′^{:,i,j}),SNR^{:,i,j}) across tones

The parameters [a_{i,j},b_{i,j}] are computed based on a K-tone interpolation as follows:
K tones with indexes tones1 and K tones with indices tones2 at opposite edges of the band are selected (e.g., 20 MHz mode)
The indices tones1 are sorted in ascending order of SNR^{k,i,j}
The indices tones2 are sorted in ascending order of SNR^{k,i,j}
The angles between corresponding elements of tones1 and tones2 are computed as:

all_angles^{i,j}=angle(C′^{tones1,i,j}·/C′^{tones2,i,j})
An estimation of the SNRs of the all_angles elements are computed as:

W^{k,i,j}=1·/(1·/SNR^{tones1,i,j}+1·/SNR^{tones2,i,l})
The coefficients a are estimated by combining the angles. Specifically:

a_{i,j}=MRC(all_angles^{i,j},W^{i,j})
The coefficients b are estimated based on the combination:

b_{i,j}=MRC(angle([C′^{tones1,i,j},C′^{tones2,i,j}]−a*[tones1,tones2],SNR^{[tones1,tones2],i,j})
The SNRs of the estimations of a, b, and c are defined as:

SNRa_{i,j}=SNRb_{i,j}=SNRc_{i,j}=sum(SNR^{[tones1,tones2],i,j})

The estimates of a, b, and c are combined across access terminals:

aⱼ=MRC(a_{:,j},SNRa_{:,j})

bⱼ=MRC(b_{:,j},SNRb_{:,j})

dⱼ=MRC(c_{:,j},SNRc_{:,j})
Finally, the combined calibration coefficients are computed as:

C″^{k,i}=dⱼ*exp(j(aⱼ*[1:Nfft]+bⱼ))

Since only a limited set of the tones are used in the algorithm, the explicit channel estimate feedback that the access point receives from its associated access terminal(s) can be limited to this subset of tones. Here, the per tone SNR measured at the access terminal is similar to the per tone SNR measured at the access point.

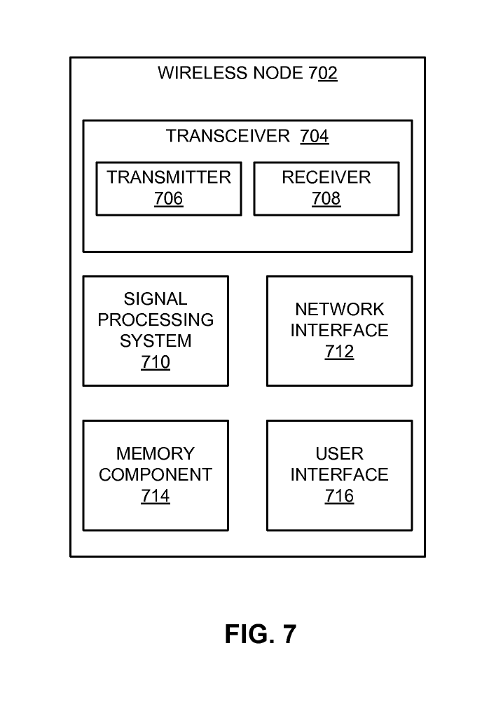

FIG. 7 illustrates several sample components (represented by corresponding blocks) that are incorporated into a wireless node 702 to perform channel estimation-related operations as taught herein. In a typical implementation, the wireless node 702 is an access point (e.g., corresponding to the access point 102 of FIG. 1). The wireless node 702 may comprise another type of device that employs multiple antennas to transmit signals in other implementations (e.g., an access terminal that sends a beamformed signal). Accordingly, the components described in FIG. 7 may be incorporated into other nodes in a communication system. Also, a given node may contain one or more of the described components. For example, a wireless node may contain multiple transceiver components that enable the wireless node to operate on multiple carriers and/or communicate via different technologies.

As shown in FIG. 7, the wireless node 702 includes one or more transceivers (as represented by a transceiver 704) for communicating with other nodes. Each transceiver 704 includes a transmitter 706 for sending signals (e.g., RF beamforming-based signals) and a receiver 708 for receiving signals (e.g., receiving radiofrequency signals via antennas, receiving radiofrequency signals comprising training messages).

As indicated in FIG. 7, in some implementations the wireless node 702 includes a network interface 712 for communicating with other nodes (e.g., network entities). Typically, the network interface 712 is configured to communicate with one or more network entities via a wire-based or wireless backhaul. In some aspects, the network interface 712 comprises a transceiver (e.g., including transmitter and receiver components) configured to support wire-based or wireless communication.

The wireless node 702 also includes other components that are used in conjunction with channel estimation-related operations as taught herein. For example, the wireless node 702 includes a signal processing system 710 for processing received signals and/or signals to be transmitted (e.g., determine a first set of coefficients based on a first pair of channel estimates acquired by the apparatus, determine at least one second set of coefficients based on at least one second pair of channel estimates acquired by the apparatus, combine the first set of coefficients and the at least one second set of coefficients to provide a combined set of coefficients, apply the combined set of coefficients to the generated channel estimate to provide a calibrated channel estimate, use the calibrated channel estimate to generate signals for beamforming-based transmission, generate a beamforming matrix based on the calibrated channel estimate, apply the beamforming matrix to a set of signals to generate signals for beamforming-based transmission, generate another channel estimate based on the received other radiofrequency signals, apply the combined set of coefficients to the other channel estimate to provide another calibrated channel estimate) and for providing other related functionality as taught herein. In some implementations, operations of the signal processing system 710 are implemented in the transceiver 704. The wireless node 702 includes a memory component 714 (e.g., including a memory device) for maintaining information (e.g., channel estimates, calibration coefficients). In some implementations, the wireless node 702 includes a user interface 716 as shown in FIG. 7 for providing indications (e.g., audible and/or visual indications) to a user and/or for receiving user input (e.g., upon user actuation of a sensing device such a microphone, a camera, a keypad, and so on).

The components of FIG. 7 may be implemented in various ways. In some implementations the components of FIG. 7 are implemented in one or more circuits such as, for example, one or more processing systems and/or one or more ASICs (which may include one or more processing systems). Here, each circuit (e.g., processing system) may use and/or incorporate memory for storing information or executable code used by the circuit to provide this functionality. For example, some of the functionality represented by block 704 and some or all of the functionality represented by blocks 710-716 may be implemented by a processing system of a wireless node and memory of the wireless node (e.g., by execution of appropriate code and/or by appropriate configuration of processing system components).

The teaching herein may be employed in wireless multiple-in-multiple-out (MIMO) system that simultaneously supports communication for multiple users (e.g., access terminals). An access point (e.g., a base station) of a MIMO system employs multiple antennas for data transmission and reception while each user employs one or more antennas. The access point communicates with the users via forward link channels and reverse link channels. A forward link (or downlink) channel refers to a communication channel from a transmit antenna of the access point to a receive antenna of a user, and a reverse link (or uplink) channel refers to a communication channel from a transmit antenna of a user to a receive antenna of the access point.

MIMO channels corresponding to transmissions from a set of transmit antennas to a receive antenna are referred to spatial streams since precoding (e.g., beamforming) is employed to direct the transmissions toward the receive antenna. Consequently, in some aspects each spatial stream corresponds to at least one dimension. A MIMO system provides improved performance (e.g., higher throughput and/or greater reliability) through the use of the additional dimensionalities provided by these spatial streams.

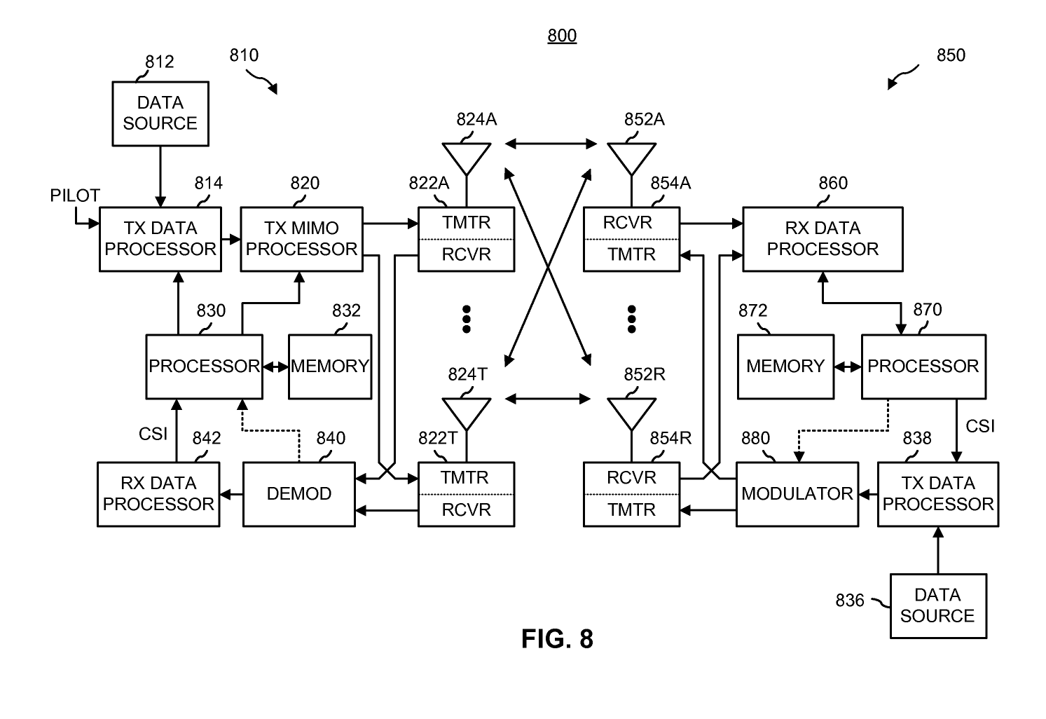

FIG. 8 illustrates in more detail sample components that may be employed in a pair of wireless nodes of a MIMO system 800. In this example, the wireless nodes are labeled as a wireless device 810 (e.g., an access point) and a wireless device 850 (e.g., an access terminal). It should be appreciated that a MU-MIMO system will include other devices (e.g., access terminals) similar to the wireless device 850. To reduce the complexity of FIG. 8, however, only one such device is shown.

The MIMO system 800 employs multiple (N_{T}) transmit antennas and multiple (N_{R}) receive antennas for data transmission. A MIMO channel formed by the N_{T} transmit and N_{R} receive antennas is decomposed into N_{S} independent channels, which are also referred to as spatial channels, where N_{S}≦min{N_{T}, N_{R}}.

The MIMO system 800 supports time division duplex (TDD) and/or frequency division duplex (FDD). In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

Referring initially to the device 810, traffic data for a number of data streams is provided from a data source 812 to a transmit (TX) data processor 814. Each data stream is then transmitted over a respective transmit antenna.

The TX data processor 814 formats, codes, and interleaves the traffic data for each data stream based on a particular coding scheme selected for that data stream to provide coded data. The coded data for each data stream is multiplexed with pilot data using OFDM techniques or other suitable techniques. The pilot data is typically a known data pattern that is processed in a known manner and used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream are typically determined by instructions performed by a processor 830. A memory 832 stores program code, data, and other information used by the processor 830 or other components of the device 810.

The modulation symbols for all data streams are then provided to a TX MIMO processor 820, which further processes the modulation symbols (e.g., for OFDM). The TX MIMO processor 820 then provides N_{T} modulation symbol streams to N_{T} transceivers (XCVR) 822A through 822T. In some aspects, the TX MIMO processor 820 applies beam-forming weights to the symbols of the data streams and to the antenna from which the symbol is being transmitted.

Each transceiver 822 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 822A through 822T are then transmitted from N_{T} antennas 824A through 824T, respectively.

At the device 850, the transmitted modulated signals are received by N_{R} antennas 852A through 852R and the received signal from each antenna 852 is provided to a respective transceiver (XCVR) 854A through 854R. Each transceiver 854 conditions (e.g., filters, amplifies, and downconverts) a respective received signal, digitizes the conditioned signal to provide samples, and further processes the samples to provide a corresponding “received” symbol stream.

A receive (RX) data processor 860 then receives and processes the N_{R} received symbol streams from N_{R} transceivers 854 based on a particular receiver processing technique to provide N_{T} “detected” symbol streams. The RX data processor 860 then demodulates, deinterleaves, and decodes each detected symbol stream to recover the traffic data for the data stream. The processing by the RX data processor 860 is complementary to that performed by the TX MIMO processor 820 and the TX data processor 814 at the device 810.

A processor 870 periodically determines which precoding matrix to use (discussed below). The processor 870 formulates a reverse link message comprising a matrix index portion and a rank value portion. A memory 872 stores program code, data, and other information used by the processor 870 or other components of the device 850.

The reverse link message comprises various types of information regarding the communication link and/or the received data stream. The reverse link message is processed by a TX data processor 838, which also receives traffic data for a number of data streams from a data source 836, modulated by a modulator 880, conditioned by the transceivers 854A through 854R, and transmitted back to the device 810.

At the device 810, the modulated signals from the device 850 are received by the antennas 824, conditioned by the transceivers 822, demodulated by a demodulator (DEMOD) 840, and processed by a RX data processor 842 to extract the reverse link message transmitted by the device 850. The processor 830 then determines which precoding matrix to use for determining the beamforming weights by processing the extracted message.

In some implementations, one or more of the TX MIMO processor 820, the TX data processor 814, or the processor 830 performs the channel estimation-related operations described herein. It should be appreciated that these operations may be performed in cooperation with other components of FIG. 8 and/or by other components of FIG. 8 in some implementations.

A wireless node may include various components that perform functions based on signals that are transmitted by or received at the wireless node. For example, in some implementations a wireless node comprises a user interface configured to provide an indication based on user input, whereupon the indication is transmitted via a plurality of antennas of the wireless node.

The teachings herein may be incorporated into (e.g., implemented within or performed by) various types of apparatuses (e.g., nodes). In some aspects, such a node comprises a wireless node. A wireless node may be portable or, in some cases, relatively non-portable. Also, in some implementations, a wireless node may be capable of transmitting and/or receiving information in a non-wireless manner (e.g., via a wired connection) via an appropriate communication interface.

In some aspects a wireless node comprises an access device (e.g., an access point) for a communication system. Such an access device provides, for example, connectivity to a service or network (e.g., a wide area network such as the Internet or a cellular network) via a wired or wireless communication link. Accordingly, the access device enables another device (e.g., a wireless station) to access such a service or network.

As discussed above, in some implementations, a wireless node implemented in accordance with the teachings is referred to as an access point. An access point may comprise, be implemented as, or known as a wireless access point, a WLAN access point, a WLAN base station, a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a wireless node implemented in accordance with the teachings is referred to as an access terminal. An access terminal may comprise, be implemented as, or known as a station, a user, a client, user equipment, a subscriber station, a subscriber unit, a mobile station, a mobile, a mobile node, a remote station, a remote terminal, a user terminal, a user agent, a user device, or some other terminology.

The teachings herein may be incorporated into (e.g., implemented within or performed by) a variety of apparatuses (e.g., devices). For example, one or more aspects taught herein may be incorporated into a phone (e.g., a cellular phone or smart phone), a portable communication device, a portable computing device (e.g., a personal data assistant), an entertainment device (e.g., a music device, a video device, or a satellite radio), a headset (e.g., headphones, an earpiece, etc.), a microphone, a medical sensing device (e.g., a sensor such as a biometric sensor, a heart rate monitor, a pedometer, an EKG device, a smart bandage, a vital signal monitor, etc.), a user I/O device (e.g., a watch, a remote control, a switch such as a light switch, a keyboard, a mouse, etc.), an environment sensing device (e.g., a tire pressure monitor), a monitor that may receive data from the medical or environment sensing device, a computer (e.g., a laptop), a point-of-sale device, a hearing aid, a set-top box, a gaming device, a global positioning system device, or any other suitable device that is configured to communicate via a wireless medium. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. The communication devices described herein may be used in sensing applications, such as for sensing automotive, athletic, physiological (medical) responses. There are other multitudes of applications that may incorporate any aspect of the disclosure as described herein.

A wireless node as taught herein may communicate via one or more wireless communication links that are based on or otherwise support any suitable wireless communication technology. For example, in some aspects a wireless node may associate with a network such as a local area network (e.g., a Wi-Fi network) or a wide area network. To this end, a wireless node may support or otherwise use one or more of a variety of wireless communication technologies, protocols, or standards such as, for example, Wi-Fi, OFDM, OFDMA, WiMAX, CDMA, or TDMA. Also, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a device may comprise a wireless transceiver with associated transmitter and receiver components that include various components (e.g., signal generators and signal processors) that facilitate communication over a wireless medium.

In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Orthogonal Frequency Division Multiple Access (OFDMA) systems, Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, or other multiple access techniques.

A wireless communication system employing the teachings herein may be designed to implement one or more standards, such as 802.11, IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

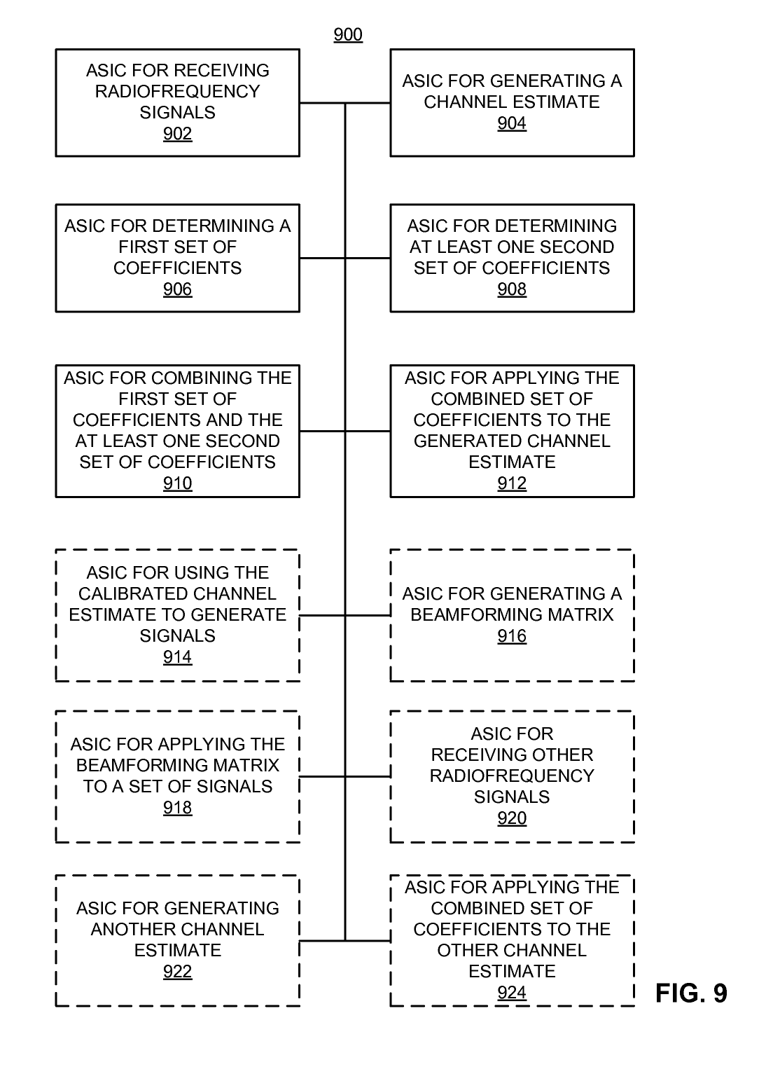

The components described herein may be implemented in a variety of ways. Referring to FIG. 9, an apparatus 900 is represented as a series of interrelated functional blocks that represent functions implemented by, for example, one or more integrated circuits (e.g., an ASIC) or implemented in some other manner as taught herein. As discussed herein, an integrated circuit may include a processing system, software, other components, or some combination thereof.

The apparatus 900 includes one or more modules that perform one or more of the functions described above with regard to various figures. For example, an ASIC for receiving radiofrequency signals 902 corresponds to, for example, a receiver (e.g., an RF receive chain) and/or a processing system as discussed herein. An ASIC for generating a channel estimate 904 corresponds to, for example, a processing system and/or transceiver as discussed herein. An ASIC for determining a first set of coefficients 906 corresponds to, for example, a processing system and/or transceiver as discussed herein. An ASIC for determining at least one second set of coefficients 908 corresponds to, for example, a processing system and/or transceiver as discussed herein. An ASIC for combining the first set of coefficients and the at least one second set of coefficients 910 corresponds to, for example, a processing system and/or transceiver as discussed herein. An ASIC for applying the combined set of coefficients to the generated channel estimate 912 corresponds to, for example, a processing system and/or transceiver as discussed herein. An ASIC for using the calibrated channel estimate to generate signals 914 corresponds to, for example, a processing system and/or transceiver as discussed herein. An ASIC for generating a beamforming matrix 916 corresponds to, for example, a processing system and/or transceiver as discussed herein. An ASIC for applying the beamforming matrix to a set of signals 918 corresponds to, for example, a processing system and/or transceiver as discussed herein. An ASIC for receiving other radiofrequency signals 920 corresponds to, for example, a receiver (e.g., an RF receive chain) and/or a processing system as discussed herein. An ASIC for generating another channel estimate 922 corresponds to, for example, a processing system and/or transceiver as discussed herein. An ASIC for applying the combined set of coefficients to the other channel estimate 924 corresponds to, for example, a processing system and/or transceiver as discussed herein.

As noted above, in some aspects these components may be implemented via appropriate processing system components. These processing system components may in some aspects be implemented, at least in part, using structure as taught herein. In some aspects a processing system may be configured to implement a portion or all of the functionality of one or more of these components. In some aspects, one or more of any components represented by dashed boxes are optional.

As noted above, the apparatus 900 comprises one or more integrated circuits in some implementations. For example, in some aspects a single integrated circuit implements the functionality of one or more of the illustrated components, while in other aspects more than one integrated circuit implements the functionality of one or more of the illustrated components.

In addition, the components and functions represented by FIG. 9 as well as other components and functions described herein, may be implemented using any suitable means. Such means are implemented, at least in part, using corresponding structure as taught herein. For example, the components described above in conjunction with the “ASIC for” components of FIG. 9 correspond to similarly designated “means for” functionality. Thus, one or more of such means is implemented using one or more of processing system components, integrated circuits, or other suitable structure as taught herein in some implementations.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Those of skill in the art understand that information and signals may be represented using any of a variety of different technologies and techniques. For example, any data, instructions, commands, information, signals, bits, symbols, and chips referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. In some aspects, a computer-readable medium comprises codes executable to perform one or more operations as taught herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A wireless communication method, comprising:
receiving radiofrequency signals at an apparatus;
generating a channel estimate based on the received radiofrequency signals;
determining a first set of coefficients based on a first pair of channel estimates acquired by the apparatus;
determining at least one second set of coefficients based on at least one second pair of channel estimates acquired by the apparatus;
combining the first set of coefficients and the at least one second set of coefficients to provide a combined set of coefficients; and
applying the combined set of coefficients to the generated channel estimate to provide a calibrated channel estimate.

2. The method of claim 1, further comprising using the calibrated channel estimate to generate signals for beamforming-based transmission.

3. The method of claim 1, further comprising:
generating a beamforming matrix based on the calibrated channel estimate; and
applying the beamforming matrix to a set of signals to generate signals for beamforming-based transmission.

4. The method of claim 1, further comprising:
receiving other radiofrequency signals at the apparatus;
generating another channel estimate based on the received other radiofrequency signals; and
applying the combined set of coefficients to the other channel estimate to provide another calibrated channel estimate.

5. The method of claim 1, wherein:
the first pair of channel estimates corresponds to channel conditions during a first period of time; and
the at least one second pair of channel estimates corresponds to channel conditions during at least one second period of time that is later than the first period of time.

6. The method of claim 1, wherein:
the first pair of channel estimates corresponds to a first set of receive antennas; and
the at least one second pair of channel estimates corresponds to at least one second set of receive antennas that is different from the first set of receive antennas.

7. The method of claim 1, wherein:
the first pair of channel estimates corresponds to transmissions at at least one first data rate; and
the at least one second pair of channel estimates corresponds to transmissions at at least one second data rate that is different from the at least one first data rate.

8. The method of claim 1, wherein:
the first set of coefficients comprises a first calibration matrix that relates a first uplink channel estimate to a first downlink channel estimate; and
the at least one second set of coefficients comprises a second calibration matrix that relates a second uplink channel estimate to a second downlink channel estimate.

9. The method of claim 8, wherein the combined set of coefficients is a vector.

10. The method of claim 1, wherein:
the first pair of channel estimates acquired by the apparatus comprises: the channel estimate generated by the apparatus, and a channel estimate received by the apparatus; and
the at least one second pair of channel estimates acquired by the apparatus comprises: another channel estimate generated by the apparatus based on other radiofrequency signals received by the apparatus, and another channel estimate received by the apparatus.

11. The method of claim 1, wherein:
the first pair of channel estimates acquired by the apparatus comprises: a first implicit channel estimate generated by the apparatus based on a first set of other radiofrequency signals received by the apparatus, and a first explicit channel estimate received by the apparatus; and
the at least one second pair of channel estimates acquired by the apparatus comprises: a second implicit channel estimate generated by the apparatus based on a second set of other radiofrequency signals received by the apparatus, and a second explicit channel estimate received by the apparatus.

12. The method of claim 1, wherein the combining of the first set of coefficients and the at least one second set of coefficients comprises maximal ratio combining.

13. The method of claim 1, wherein the combining of the first set of coefficients and the at least one second set of coefficients comprises combining that is weighted based on signal-to-noise ratios associated with the first set of coefficients and signal-to-noise ratios associated with the at least one second set of coefficients.

14. The method of claim 1, wherein the combining of the first set of coefficients and the at least one second set of coefficients comprises:
scaling the first set of coefficients and the at least one second set of coefficients;
for each transmit antenna of a plurality of transmit antennas at the apparatus, combining the scaled coefficients of the first set of coefficients and the at least one second set of coefficients that are associated with the transmit antenna; and
normalizing the combined coefficients associated with each transmit antenna with respect to a first one of the transmit antennas.

15. The method of claim 14, wherein the combining of the first set of coefficients and the at least one second set of coefficients comprises generating a corresponding calibration vector for each tone of a set of orthogonal frequency division multiplexing tones used by the apparatus.

16. The method of claim 1, wherein the combining of the first set of coefficients and the at least one second set of coefficients comprises:
determining sets of linear interpolation phase and amplitude parameters associated with a set of orthogonal frequency division multiplexing tones used by the apparatus;
combining the sets of linear interpolation phase and amplitude parameters to provide a combined set of linear interpolation parameters; and
calculating the combined set of coefficients based on the combined set of linear interpolation parameters.

17. An apparatus for wireless communication, comprising:
a receiver configured to receive radiofrequency signals; and
a processing system configured to generate a channel estimate based on the received radiofrequency signals, determine a first set of coefficients based on a first pair of channel estimates acquired by the apparatus, determine at least one second set of coefficients based on at least one second pair of channel estimates acquired by the apparatus, combine the first set of coefficients and the at least one second set of coefficients to provide a combined set of coefficients, and apply the combined set of coefficients to the generated channel estimate to provide a calibrated channel estimate.

18. The apparatus of claim 17, wherein the processing system is further configured to use the calibrated channel estimate to generate signals for beamforming-based transmission.

19. The apparatus of claim 17, wherein the processing system is further configured to:
generate a beamforming matrix based on the calibrated channel estimate; and
apply the beamforming matrix to a set of signals to generate signals for beamforming-based transmission.

20. The apparatus of claim 17, wherein:
the receiver is further configured to receive other radiofrequency signals;
the processing system is further configured to generate another channel estimate based on the received other radiofrequency signals; and
the processing system is further configured to apply the combined set of coefficients to the other channel estimate to provide another calibrated channel estimate.

21. The apparatus of claim 17, wherein:
the first pair of channel estimates corresponds to channel conditions during a first period of time; and
the at least one second pair of channel estimates corresponds to channel conditions during at least one second period of time that is later than the first period of time.

22. The apparatus of claim 17, wherein:
the first pair of channel estimates corresponds to a first set of receive antennas; and
the at least one second pair of channel estimates corresponds to at least one second set of receive antennas that is different from the first set of receive antennas.

23. The apparatus of claim 17, wherein:
the first pair of channel estimates corresponds to transmissions at at least one first data rate; and
the at least one second pair of channel estimates corresponds to transmissions at at least one second data rate that is different from the at least one first data rate.

24. The apparatus of claim 17, wherein:
the first set of coefficients comprises a first calibration matrix that relates a first uplink channel estimate to a first downlink channel estimate; and
the at least one second set of coefficients comprises a second calibration matrix that relates a second uplink channel estimate to a second downlink channel estimate.

25. The apparatus of claim 24, wherein the combined set of coefficients is a vector.

26. The apparatus of claim 17, wherein:
the first pair of channel estimates acquired by the apparatus comprises: the channel estimate generated by the apparatus, and a channel estimate received by the apparatus; and
the at least one second pair of channel estimates acquired by the apparatus comprises: another channel estimate generated by the apparatus based on other radiofrequency signals received by the apparatus, and another channel estimate received by the apparatus.

27. The apparatus of claim 17, wherein:
the first pair of channel estimates acquired by the apparatus comprises: a first implicit channel estimate generated by the apparatus based on a first set of other radiofrequency signals received by the apparatus, and a first explicit channel estimate received by the apparatus; and
the at least one second pair of channel estimates acquired by the apparatus comprises: a second implicit channel estimate generated by the apparatus based on a second set of other radiofrequency signals received by the apparatus, and a second explicit channel estimate received by the apparatus.

28. The apparatus of claim 17, wherein the combining of the first set of coefficients and the at least one second set of coefficients comprises maximal ratio combining.

29. The apparatus of claim 17, wherein the combining of the first set of coefficients and the at least one second set of coefficients comprises combining that is weighted based on signal-to-noise ratios associated with the first set of coefficients and signal-to-noise ratios associated with the at least one second set of coefficients.

30. The apparatus of claim 17, wherein the combining of the first set of coefficients and the at least one second set of coefficients comprises:
scaling the first set of coefficients and the at least one second set of coefficients;
for each transmit antenna of a plurality of transmit antennas at the apparatus, combining the scaled coefficients of the first set of coefficients and the at least one second set of coefficients that are associated with the transmit antenna; and
normalizing the combined coefficients associated with each transmit antenna with respect to a first one of the transmit antennas.

31. The apparatus of claim 30, wherein the combining of the first set of coefficients and the at least one second set of coefficients comprises generating a corresponding calibration vector for each tone of a set of orthogonal frequency division multiplexing tones used by the apparatus.

32. The apparatus of claim 17, wherein the combining of the first set of coefficients and the at least one second set of coefficients comprises:
determining sets of linear interpolation phase and amplitude parameters associated with a set of orthogonal frequency division multiplexing tones used by the apparatus;
combining the sets of linear interpolation phase and amplitude parameters to provide a combined set of linear interpolation parameters; and
calculating the combined set of coefficients based on the combined set of linear interpolation parameters.

33. An apparatus for wireless communication, comprising:
means for receiving radiofrequency signals;
means for generating a channel estimate based on the received radiofrequency signals;
means for determining a first set of coefficients based on a first pair of channel estimates acquired by the apparatus;
means for determining at least one second set of coefficients based on at least one second pair of channel estimates acquired by the apparatus;
means for combining the first set of coefficients and the at least one second set of coefficients to provide a combined set of coefficients; and
means for applying the combined set of coefficients to the generated channel estimate to provide a calibrated channel estimate.

34. The apparatus of claim 33, further comprising means for using the calibrated channel estimate to generate signals for beamforming-based transmission.

35. The apparatus of claim 33, further comprising:
means for generating a beamforming matrix based on the calibrated channel estimate; and
means for applying the beamforming matrix to a set of signals to generate signals for beamforming-based transmission.

36. The apparatus of claim 33, further comprising:
means for receiving other radiofrequency signals;
means for generating another channel estimate based on the received other radiofrequency signals; and
means for applying the combined set of coefficients to the other channel estimate to provide another calibrated channel estimate.

37. The apparatus of claim 33, wherein:
the first pair of channel estimates corresponds to channel conditions during a first period of time; and
the at least one second pair of channel estimates corresponds to channel conditions during at least one second period of time that is later than the first period of time.

38. The apparatus of claim 33, wherein:
the first pair of channel estimates corresponds to a first set of receive antennas; and
the at least one second pair of channel estimates corresponds to at least one second set of receive antennas that is different from the first set of receive antennas.

39. The apparatus of claim 33, wherein:
the first pair of channel estimates corresponds to transmissions at at least one first data rate; and
the at least one second pair of channel estimates corresponds to transmissions at at least one second data rate that is different from the at least one first data rate.

40. The apparatus of claim 33, wherein:
the first set of coefficients comprises a first calibration matrix that relates a first uplink channel estimate to a first downlink channel estimate; and
the at least one second set of coefficients comprises a second calibration matrix that relates a second uplink channel estimate to a second downlink channel estimate.

41. The apparatus of claim 40, wherein the combined set of coefficients is a vector.

42. The apparatus of claim 33, wherein:
the first pair of channel estimates acquired by the apparatus comprises: the channel estimate generated by the apparatus, and a channel estimate received by the apparatus; and
the at least one second pair of channel estimates acquired by the apparatus comprises: another channel estimate generated by the apparatus based on other radiofrequency signals received by the apparatus, and another channel estimate received by the apparatus.

43. The apparatus of claim 33, wherein:
the first pair of channel estimates acquired by the apparatus comprises: a first implicit channel estimate generated by the apparatus based on a first set of other radiofrequency signals received by the apparatus, and a first explicit channel estimate received by the apparatus; and
the at least one second pair of channel estimates acquired by the apparatus comprises: a second implicit channel estimate generated by the apparatus based on a second set of other radiofrequency signals received by the apparatus, and a second explicit channel estimate received by the apparatus.

44. The apparatus of claim 33, wherein the combining of the first set of coefficients and the at least one second set of coefficients comprises maximal ratio combining.

45. The apparatus of claim 33, wherein the combining of the first set of coefficients and the at least one second set of coefficients comprises combining that is weighted based on signal-to-noise ratios associated with the first set of coefficients and signal-to-noise ratios associated with the at least one second set of coefficients.

46. The apparatus of claim 33, wherein the combining of the first set of coefficients and the at least one second set of coefficients comprises:
scaling the first set of coefficients and the at least one second set of coefficients;
for each transmit antenna of a plurality of transmit antennas at the apparatus, combining the scaled coefficients of the first set of coefficients and the at least one second set of coefficients that are associated with the transmit antenna; and
normalizing the combined coefficients associated with each transmit antenna with respect to a first one of the transmit antennas.

47. The apparatus of claim 46, wherein the combining of the first set of coefficients and the at least one second set of coefficients comprises generating a corresponding calibration vector for each tone of a set of orthogonal frequency division multiplexing tones used by the apparatus.

48. The apparatus of claim 33, wherein the combining of the first set of coefficients and the at least one second set of coefficients comprises:
determining sets of linear interpolation phase and amplitude parameters associated with a set of orthogonal frequency division multiplexing tones used by the apparatus;
combining the sets of linear interpolation phase and amplitude parameters to provide a combined set of linear interpolation parameters; and
calculating the combined set of coefficients based on the combined set of linear interpolation parameters.

49. A computer-program product for wireless communication, comprising:
computer-readable medium comprising codes executable to:
receive radiofrequency signals at an apparatus;
generate a channel estimate based on the received radiofrequency signals;
determine a first set of coefficients based on a first pair of channel estimates acquired by the apparatus;
determine at least one second set of coefficients based on at least one second pair of channel estimates acquired by the apparatus;
combine the first set of coefficients and the at least one second set of coefficients to provide a combined set of coefficients; and
apply the combined set of coefficients to the generated channel estimate to provide a calibrated channel estimate.

50. A wireless node, comprising:
a plurality of antennas;
a receiver configured to receive radiofrequency signals via the antennas; and
a processing system configured to generate a channel estimate based on the received radiofrequency signals, determine a first set of coefficients based on a first pair of channel estimates acquired by the wireless node, determine at least one second set of coefficients based on at least one second pair of channel estimates acquired by the wireless node, combine the first set of coefficients and the at least one second set of coefficients to provide a combined set of coefficients, and apply the combined set of coefficients to the generated channel estimate to provide a calibrated channel estimate.
